(19) United States
(12) Patent Application Publication
(10) Pub. No.: US 2026/0131666 A1
(43) Pub. Date: May 14, 2026

(54) ELECTRIFIED VEHICLE AND METHOD OF CONTROLLING SAME

(71) Applicants: HYUNDAI MOTOR COMPANY, SEOUL (KR); KIA CORPORATION, SEOUL (KR)

(72) Inventors: Ho Sun Jang, Hwaseong-si (KR); Seung Hyeon Bin, Hwaseong-si (KR); Hee Won An, Hwaseong-si (KR); Joon Ha Hwang, Hwaseong-si (KR); Seong Min Kim, Hwaseong-si (KR); Byung Oh Tak, Hwaseong-si (KR)

(73) Assignees: HYUNDAI MOTOR COMPANY, SEOUL (KR); KIA CORPORATION, SEOUL (KR)

(21) Appl. No.: 19/229,629

(22) Filed: Jun. 5, 2025

(30) Foreign Application Priority Data
Nov. 13, 2024 (KR) 10-2024-0160660

(51) Int. Cl. B60L 15/20; B60L 15/00; B60L 50/60; H02M 7/537

(52) U.S. Cl. CPC B60L 15/20; B60L 15/007; B60L 50/60; H02M 7/537; B60L 2240/421; B60L 2240/423; B60L 2260/26

(57) ABSTRACT

Disclosed are an electrified vehicle and a method of controlling the same. A driving mode of a motor is controlled on the basis of a first switching condition with respect to a target operating point and a second switching condition with respect to required output power of the motor, and output power of an auxiliary battery in a state in which the electrified vehicle is equipped with the auxiliary battery.

### CROSS REFERENCE TO RELATED APPLICATIONS

This application claims priority from Korean Patent Application No. 10-2024-0160660, filed on Nov. 13, 2024 in the Korean Intellectual Property Office, the disclosure of which is incorporated herein by reference in its entirety.

### BACKGROUND

### 1. Field

The present disclosure relates to an electrified vehicle capable of being equipped with an auxiliary battery in addition to a main battery and a method of controlling the same.

### 2. Description of the Related Art

Recently, the demand for electrified vehicles that generate driving power by driving a motor with electric energy stored in a battery instead of typical internal combustion engine vehicles that generate driving power by burning fossil fuels has been greatly increasing due to the global trend of reducing carbon dioxide emissions.

In the case of electrified vehicles, the time required to charge a battery is relatively long compared to the refueling time of an internal combustion engine vehicle, and thus the maximum all-electric range that a vehicle can travel by fully charging the battery once is important.

The maximum all-electric range of an electrified vehicle may vary depending on the voltage and capacity of the battery. Even if the battery has the same capacity, the voltage and charge amount may vary depending on the combination of serial/parallel connections between modules or cells. For example, the voltage of the battery may correspond to the value obtained by multiplying the voltage of battery cells by the number of cells connected in series, and the charge amount of the battery may correspond to the value obtained by multiplying the charge amount of the battery cells by the number of cells connected in parallel.

Accordingly, a method of increasing the battery voltage may be considered in order to increase the all-electric range, but since the withstand voltage design of the motor system also need to be strengthened when the voltage of the battery increases, a method of increasing the all-electric range without increasing the voltage of the battery needs to be presented.

The matters described as the background technology above are only for the purpose of increasing understanding of the background of the present disclosure and should not be recognized as corresponding to prior art already known to those skilled in the art.

### SUMMARY

Therefore, the present disclosure has been made in view of the above problems, and it is an object of the present disclosure to provide an electrified vehicle capable of efficiently utilizing the output power of an auxiliary battery and a method of controlling the same.

The object to be achieved in the present disclosure is not limited to the object mentioned above, and other objects not mentioned will be clearly understood by those skilled in the art to which the present disclosure belongs from the description below.

In accordance with an aspect of the present disclosure, the above and other objects can be accomplished by the provision of an electrified vehicle capable of being equipped with an auxiliary battery, including a motor having a plurality of windings, a first inverter including a plurality of legs each connected to one end of each of the plurality of windings, a main battery connected to the first inverter, and a controller configured to selectively control a driving mode of the motor between a first driving mode in which the motor is driven using only output power of the main battery and a second driving mode in which the motor is driven using the output power of the main battery and output power of the auxiliary battery together on the basis of a first switching condition with respect to a target operating point according to a required torque of the motor and a second switching condition with respect to a required output power of the motor and the output power of the auxiliary battery, in a state in which the electrified vehicle is equipped with the auxiliary battery.

In accordance with another aspect of the present disclosure, there is provided a method of controlling an electrified vehicle including a motor having a plurality of windings, a first inverter including a plurality of legs each connected to one end of each of the plurality of windings, and a main battery connected to the first inverter, and capable of being equipped with an auxiliary battery, the method including selectively controlling a driving mode of the motor between a first driving mode in which the motor is driven using only output power of the main battery and a second driving mode in which the motor is driven using the output power of the main battery and output power of the auxiliary battery together on the basis of a first switching condition with respect to a target operating point according to a required torque of the motor and a second switching condition with respect to a required output power of the motor and the output power of the auxiliary battery, in a state in which the electrified vehicle is equipped with the auxiliary battery.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a diagram showing a configuration of an electrified vehicle according to an embodiment of the present disclosure;

FIG. 2 is a diagram illustrating examples of operation of a motor system applicable to embodiments of the present disclosure;

FIG. 3 is a diagram illustrating examples of operation of a motor system applicable to embodiments of the present disclosure;

FIG. 4 is a diagram illustrating a first driving mode and a second driving mode according to an embodiment of the present disclosure;

FIG. 5 is a diagram illustrating output efficiency depending on whether a second switching condition is satisfied according to an embodiment of the present disclosure;

FIG. 6 is a diagram illustrating output efficiency depending on whether a second switching condition is satisfied according to an embodiment of the present disclosure; and

FIG. 7 is a diagram illustrating a method of controlling an electrified vehicle according to an embodiment of the present disclosure.

### DETAILED DESCRIPTION

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure can be modified in various manners and have various forms, specific embodiments will be illustrated in the drawings and described in detail in the specification or application. However, this is not intended to limit the embodiments according to the concept of the present disclosure to a specific disclosed form, and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, identical or similar components will be assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit” or “part” used to signify components are used herein to help the understanding of the components and thus they should not be considered as having specific meanings or roles.

In the following description of the embodiments disclosed in the present specification, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) is merely a term widely used in naming a control device that controls specific vehicle functions and does not mean a generic functional unit.

A controller may include a communication device that communicates with other controllers or sensors to control the functions of the controller, a memory that stores an operating system, logic instructions, input/output information, etc., and one or more processors that perform determination, computation, and decisions necessary to control the functions.

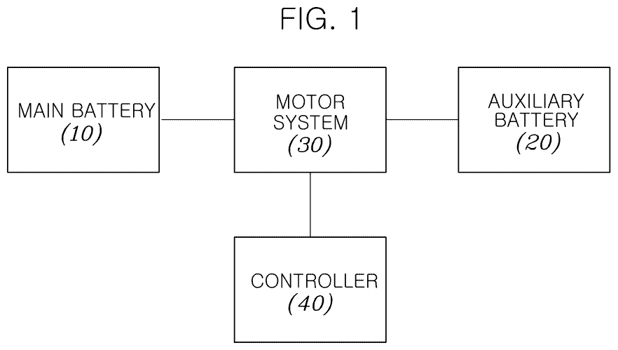

Hereinafter, a configuration of an electrified vehicle according to an embodiment of the present disclosure will be described with reference to FIG. 1 to FIG. 8.

FIG. 1 is a diagram showing a configuration of an electrified vehicle according to an embodiment of the present disclosure.

Referring to FIG. 1, the electrified vehicle according to an embodiment may include a main battery 10, a motor system 30, and a controller 40, and may be equipped with an auxiliary battery 20. Hereinafter, the description will be given on the assumption that the electrified vehicle according to an embodiment is equipped with the auxiliary battery 20.

The motor system 30 may include a motor that serves as a power source of the electrified vehicle and at least one inverter for driving the motor, and may be connected between the main battery 10 and the auxiliary battery 20.

More specifically, the motor system 30 may drive the motor through the operation of the inverter based on the voltage of the main battery 10.

In addition, in the electrified vehicle according to an embodiment, the auxiliary battery 20 may be selectively connected to the motor system 30, and when the auxiliary battery 20 is connected to the motor system 30, the auxiliary battery 20 may supply power to the motor system 30. In embodiments of the present disclosure, the auxiliary battery 20 is distinguished from the main battery 10, and for example, the capacity or voltage of the auxiliary battery 20 may have a value equal to or less than the capacity or voltage of the main battery 10. In addition, the auxiliary battery 20 is also distinguished from a low-voltage (for example, 12 V) battery for operating electrical components in that the auxiliary battery 20 may be used to drive the motor 31, and the auxiliary battery 20 may have a capacity or voltage greater than that of the low-voltage battery for operating electrical components.

In this case, the auxiliary battery 20 may be used as a power source for driving the motor, or may be used to charge the main battery 10 by supplying power to the main battery 10 through the motor system 30. In addition, the auxiliary battery 20 may be charged by receiving power from the main battery 10 through the motor system 30.

The controller 40 may control the switching state of the inverter included in the motor system 30. In addition, the controller 40 may control the driving mode of the motor depending on whether the auxiliary battery 20 outputs power.

The driving mode includes a first driving mode in which the motor is driven using only the output of the main battery 10 and a second driving mode in which the motor is driven using the output of the main battery 10 and the output of the auxiliary battery 20 together.

The controller 40 drives the motor in a state in which the auxiliary battery 20 and the motor of the motor system 30 are electrically disconnected in the first driving mode, and drives the motor in a state in which the auxiliary battery 20 and the motor of the motor system 30 are electrically connected in the second driving mode.

In operation, the controller 40 may be implemented as a single controller or may be implemented in a form in which functions thereof are distributed to a plurality of controllers. For example, the controller 40 may be implemented as a combination of a motor control unit (MCU) that controls the motor of the motor system 30 and a higher controller thereof (e.g., a hybrid control unit (HCU), a vehicle integrated control unit (VCU), a hydrogen fuel cell control unit (FCCU), etc.), but the present disclosure is not limited thereto. According to another implementation, the controller 40 may further include a charging controller.

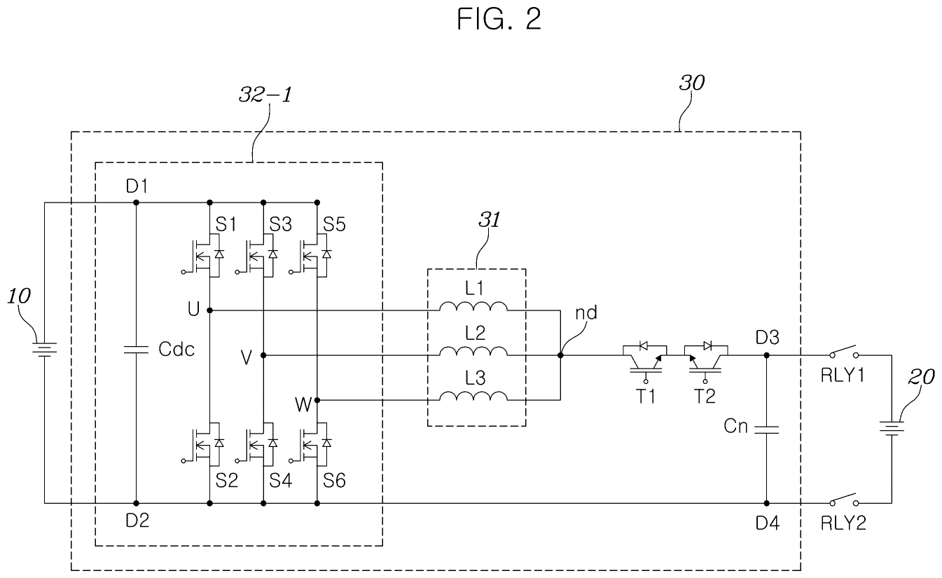

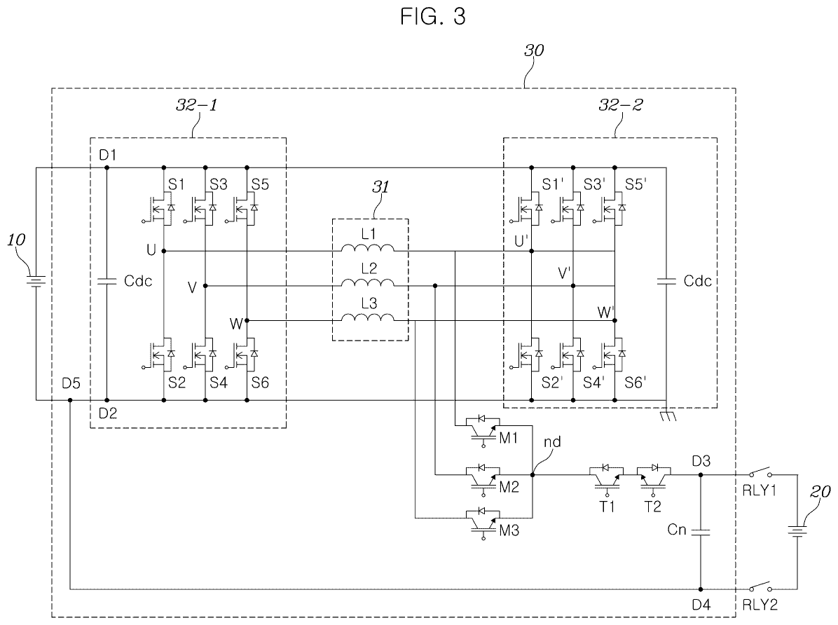

As described above, the motor system 30 may be electrically connected not only to the main battery 10 but also to the auxiliary battery 20, and in this case, the all-electric range may be increased by driving the motor using the power of the auxiliary battery 20. Configurations for achieving this are illustrated in FIG. 2 and FIG. 3.

FIG. 2 and FIG. 3 are diagrams illustrating examples of operation of the motor system applicable to embodiments of the present disclosure.

More specifically, FIG. 2 shows an example in which the motor system 30 is implemented in a configuration having a single inverter 32-1, and FIG. 3 shows an example in which the motor system 30 is implemented in a configuration having dual inverters 32-1 and 32-2.

First, referring to FIG. 2, the motor system 30 according to an embodiment may include a motor 31, a first inverter 32-1, charging switches T1 and T2, and DC capacitors Cdc and Cn. In addition, the motor system 30 may include DC terminals D1, D2, D3, and D4 connected to the main battery 10 and the auxiliary battery 20.

More specifically, the motor 31 may include a plurality of windings L1, L2, and L3 corresponding to a plurality of phases U, V, and W. The first inverter 32-1 may have DC terminals D1 and D2 connected to the main battery 10 and may include a plurality of legs S1-S2, S3-S4, and S5-S6 each connected to one end of each of the plurality of windings L1, L2, and L3 included in the motor 31.

The charging switches T1 and T2 may be connected between the other ends of the plurality of windings L1, L2, and L3 included in the motor 31 and the auxiliary battery 20. More specifically, the charging switches T1 and T2 may be connected between a node nd at which the plurality of windings L1, L2, and L3 is interconnected to form a neutral point of the motor 31 and the anode of the auxiliary battery 20. In one embodiment, the charging switches T1 and T2 may be implemented as an insulated gate bipolar transistor (IGBT), but may also be implemented as other elements capable of performing a switching operation, such as a metal oxide semiconductor field effect transistor (MOSFET), depending on the embodiment. Although the charging switches T1 and T2 are connected in series in FIG. 2 and FIG. 3, the connection structure of the charging switches T1 and T2 is not necessarily limited thereto.

The first driving mode or the second driving mode described above may be executed according to the turn-on/off states of the charging switches T1 and T2. More specifically, in the first driving mode, the charging switches T1 and T2 are turned off, and in this case, the node nd and the auxiliary battery 20 are electrically separated, and thus the auxiliary battery 20 is disconnected from the motor 31. On the other hand, in the second driving mode, the charging switches T1 and T2 are turned on, and in this case, the node nd and the auxiliary battery 20 are electrically connected, and thus the auxiliary battery 20 is connected to the motor 31.

The motor system 30 may be connected to the auxiliary battery 20 via relays RLY1 and RLY2. In this case, the relay RLY1 may be connected between the anode of the auxiliary battery 20 and the DC terminal D3, and the relay RLY2 may be connected between the cathode of the auxiliary battery 20 and the DC terminal D4.

In the embodiments, a “state in which the auxiliary battery 20 is mounted” may mean a case in which the relays RLY1 and RLY2 are turned on and thus the auxiliary battery 20 is connected to the motor system 30. However, even when the relays RLY1 and RLY2 are turned on and the auxiliary battery 20 is mounted, the auxiliary battery 20 may be electrically connected to or disconnected from the motor 31 depending on the turn-on/off states of the charging switches T1 and T2.

More specifically, the anode of the auxiliary battery 20 may be connected to the node nd formed at the other end of each of the plurality of windings L1, L2 and L3, and the cathode of the auxiliary battery 20 may be selectively connected to the DC terminal D4 through the charging switches T1 and T2 and the relays RLY1 and RLY2.

As shown in FIG. 1, an additional relay may not be provided between the main battery 10 and the motor system 30), but a relay may also be provided between the main battery 10 and the motor system 30 depending on the embodiment.

The DC capacitors Cdc and Cn may be provided to alleviate current ripples. More specifically, the DC capacitor Cdc connected between the DC terminal D1 and the DC terminal D2 can alleviate ripples in the current of the main battery 10, and the DC capacitor Cn connected between the DC terminal D3 and the DC terminal D4 can alleviate ripples in the current of the auxiliary battery 20.

Hereinafter, the motor system 30 illustrated in FIG. 3 will be described focusing on differences from the motor system 30 illustrated in FIG. 2.

Referring to FIG. 3, in an embodiment, the motor system 30 according to an embodiment may further include a second inverter 32-2 and a plurality of switches M1, M2, and M3 in comparison with FIG. 2.

The second inverter 32-2 may include a plurality of legs S1′-S2′, S3′-S4′, and S5′-S6′ connected to the other ends of the plurality of windings L1, L2, and L3.

One end of each of the plurality of switches M1, M2, and M3 may be connected to the other end of each of the plurality of windings L1, L2, and L3, and the other ends of the switches M1, M2, and M3 may be interconnected to form a node nd. The plurality of switches M1, M2, and M3 may determine a detailed driving mode through the first inverter 32-1 and the second inverter 32-2 in the first driving mode.

More specifically, the first driving mode may include a closed end winding (CEW) mode and an open end winding (OEW) mode. First, in the CEW mode, the plurality of switches M1, M2, and M3 is turned on. In this case, the node nd becomes the neutral point of the motor 31 and the motor 31 is driven only through the first inverter 32-1. The CEW mode can be executed for efficient driving of the motor 31 in a low output range.

On the other hand, in the OEW mode in the first driving mode, the plurality of switches M1, M2, and M3 is turned off. In this case, the node nd does not become the neutral point of the motor 31, and the second inverter 32-2 can drive the motor 31 along with the first inverter 32-1. The OEW mode can be executed to increase the driving power of the motor 31 in a high output range.

In this dual inverter (32-1 and 32-2) structure, the auxiliary battery 20 may be connected between the other end of each of the plurality of windings L1, L2, and L3 and the DC terminal D5. More specifically, through the charging switches T1 and T2 and the relays RLY1 and RLY2, the anode of the auxiliary battery 20 may be connected to the node nd formed at the other ends of the plurality of switching switches M1, M2, and M3, and the cathode of the auxiliary battery 20 may be connected to the DC terminal D5.

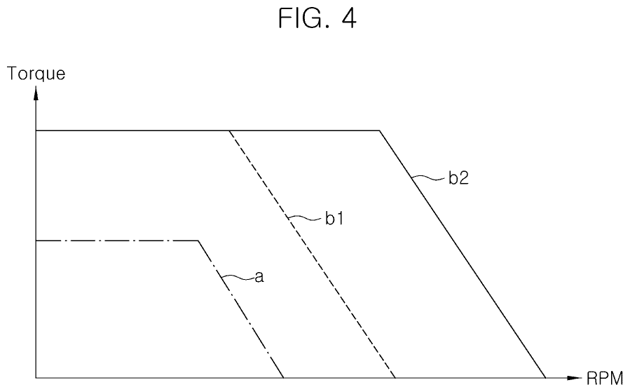

Hereinafter, operation ranges of the first driving mode and the second driving mode will be briefly described with reference to FIG. 4.

FIG. 4 is a diagram illustrating the first driving mode and the second driving mode according to an embodiment of the present disclosure.

Referring to FIG. 4, the operation ranges of the first driving mode and the second driving mode may be represented as a graph with respect to the rotation speed and torque of the motor 31.

The CEW mode may be performed in a low-output range where the rotation speed and torque are relatively low compared to the OEW mode, whereas the OEW mode may be performed in a high-output range where the rotation speed and torque are relatively high compared to the CEW mode.

The second driving mode may be performed when a first switching condition and a second switching condition are satisfied within the operation range of the CEW mode, and can be performed in the lowest output range where the rotation speed and torque are low. By utilizing the auxiliary battery 20 together with the main battery 10 to drive the motor 31 in the lowest output range, the all-electric range can be increased.

In an embodiment of the present disclosure, the first switching condition for a target operating point according to the required torque of the motor may be determined by the output range according to the rotation speed and torque.

More specifically, the controller 40 may determine that the first switching condition is satisfied when the target operating point is included in an area below a torque limit line a for each rotation speed of the motor.

Here, the torque limit line a for each rotation speed of the motor is included in an area below torque upper limit lines b1 and b2 for each rotation speed of the motor in the first driving mode. That is, the first switching condition can be satisfied when the target operating point is included in the lowest output range.

In an embodiment, in addition to the first switching condition according to the target operating point, the second switching condition according to the required output power of the motor and the output power of the auxiliary battery is additionally considered to control the driving mode of the motor, thereby improving the output power efficiency of the auxiliary battery.

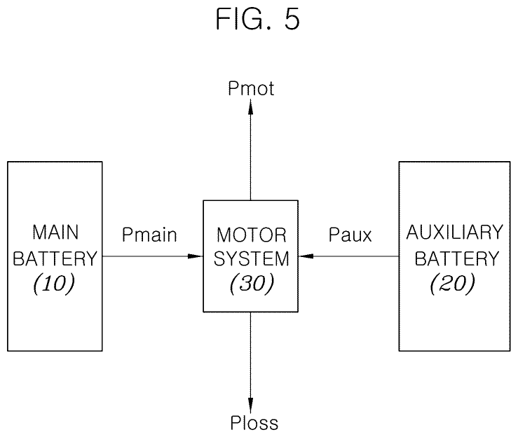

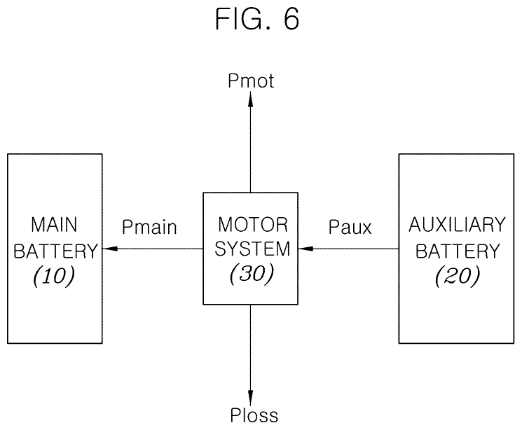

In this regard, the following description will be provided with reference to FIG. 5 and FIG. 6.

FIG. 5 and FIG. 6 are diagrams illustrating output power efficiency according to whether the second switching condition is satisfied according to an embodiment of the present disclosure.

First, referring to FIG. 5, an output flow when the second switching condition is satisfied according to an embodiment is illustrated.

The second switching condition relates to the required output power Pmot of the motor and the output power Paux of the auxiliary battery 20, and can be satisfied when the required output power Pmot of the motor exceeds the output power Paux of the auxiliary battery 20.

When both the first switching condition and the second switching condition are satisfied, the controller 40 controls the driving mode of the motor to switch to the second driving mode. In this case, the required output power Pmot of the motor is satisfied through the output power Pmain of the main battery 10 and the output power Paux of the auxiliary battery 20, and only a loss Ploss in the process in which the output power of the main battery 10 and the output power of the auxiliary battery 20 are transmitted to the motor system 30 is generated.

On the other hand, FIG. 6 illustrates an output flow when the second switching condition is not satisfied, that is, when the required output power Pmot of the motor is equal to or less than the output power Paux of the auxiliary battery 20. In this case, some of the output power Paux of the auxiliary battery 20 is used to satisfy the required output power Pmot of the motor, and the remainder is used to charge the main battery 10.

In this case, since the output power Paux of the auxiliary battery 20 is transferred to the main battery 10 and then later output from the main battery 10, the power loss Ploss increases compared to a case in which the output power Paux of the auxiliary battery 20 is entirely used for the output power of the motor, as in FIG. 5. Therefore, the controller 40 can improve the output power efficiency of the auxiliary battery 20 by disallowing entry into the second driving mode and controlling the driving mode of the motor to switch to the first driving mode when the second switching condition is not satisfied.

Hereinafter, a method of controlling an electrified vehicle according to an embodiment of the present disclosure will be described.

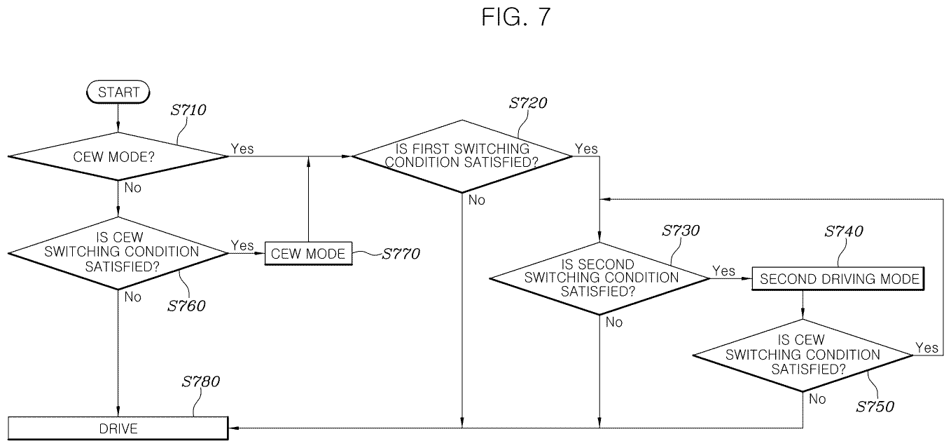

FIG. 7 is a diagram illustrating a method of controlling an electrified vehicle according to an embodiment of the present disclosure.

First, the controller 40 checks whether the driving mode of the motor is the CEW mode (S710), and if the driving mode of the motor is the CEW mode (Yes in S710), determines whether the first switching condition is satisfied (S720) and whether the second switching condition is satisfied (S730).

In this case, whether the first switching condition is satisfied may be determined on the basis of a target operating point of the motor and a torque limit line for each rotation speed of the motor, and whether the second switching condition is satisfied may be determined by comparing the output power of the auxiliary battery 20 and the required output power of the motor.

If both the first switching condition and the second switching condition are satisfied (Yes in S720 and Yes in S730), the controller 40 controls the driving mode to switch to the second driving mode in which the motor is driven using the output power of the auxiliary battery 20 together with the main battery 10 (S740).

Thereafter, if a condition for switching to the CEW mode is satisfied during the operation of the second driving mode (Yes in S750), the controller 40 cuts off the electrical connection between the auxiliary battery 20 and the motor and drives the motor in the CEW mode (S780).

On the other hand, if the driving mode of the motor is not the CEW mode (No in S710), the above-described process may not be performed, and if the condition for switching to the CEW mode is satisfied during execution of the OEW mode or the second driving mode (Yes in S760) and the motor enters the CEW mode (S770), the driving mode is controlled on the basis of the first switching condition and the second switching condition.

According to various embodiments of the present disclosure as described above, an auxiliary battery can be utilized for driving a motor together with a main battery, and thus the all-electric range of an electrified vehicle can be efficiently increased.

Furthermore, in an electrified vehicle capable of being equipped with an auxiliary battery, it is possible to alleviate efficiency decrease due to an output loss of the auxiliary battery by controlling the output power of the auxiliary battery in consideration of conditions for required output power of the motor and the output power of the auxiliary battery along with a target operating point according to a required torque of the motor.

The effects that can be obtained from the present disclosure are not limited to the effects mentioned above, and other effects not mentioned will be clearly understood by those skilled in the art to which the present disclosure belongs from the description below.

Although the present disclosure has been illustrated and described with respect to specific embodiments as described above, it will be apparent to those skilled in the art that the present disclosure can be improved and changed in various manners without departing from the technical spirit of the present disclosure provided by the following claims.

1. An electrified vehicle capable of being equipped with an auxiliary battery, including:
a motor including a plurality of windings;
a first inverter including a plurality of legs, wherein each leg of the plurality of legs is connected to one end of each of the plurality of windings;
a main battery connected to the first inverter; and
a controller configured to selectively control a driving mode of the motor between a first driving mode in which the motor is driven using only output power of the main battery and a second driving mode in which the motor is driven using the output power of the main battery and output power of the auxiliary battery together based on a first switching condition with respect to a target operating point according to a required torque of the motor and a second switching condition with respect to a required output power of the motor and the output power of the auxiliary battery, in a state in which the electrified vehicle is equipped with the auxiliary battery.

2. The electrified vehicle of claim 1, wherein the controller drives the motor in a state in which the auxiliary battery is electrically disconnected from the motor in the first driving mode, and in the second driving mode, drives the motor in a state in which the auxiliary battery is electrically connected to a node to which other ends of the plurality of windings are connected.

3. The electrified vehicle of claim 1, wherein the controller determines that the first switching condition is satisfied, based on the target operating point being included in an area below a torque limit line for each rotation speed of the motor.

4. The electrified vehicle of claim 3, wherein the torque limit line is included in an area below a torque upper limit line for each rotation speed of the motor in the first driving mode.

5. The electrified vehicle of claim 1, wherein the controller determines that the second switching condition is satisfied, based on the required output power of the motor exceeding the output power of the auxiliary battery.

6. The electrified vehicle of claim 1, wherein the controller controls the driving mode of the motor to switch to the second driving mode, based on both the first switching condition and the second switching condition being satisfied.

7. The electrified vehicle of claim 1, wherein the controller controls the driving mode of the motor to switch to the first driving mode, based on at least one of the first switching condition and the second switching condition being not satisfied.

8. The electrified vehicle of claim 1, further including a second inverter including a plurality of legs connected to other ends of the plurality of windings and connected to the main battery,
wherein the first driving mode includes a CEW mode in which the motor is driven using only the first inverter and an OEW mode in which the motor is driven through the first inverter and the second inverter.

9. The electrified vehicle of claim 8, further including a plurality of switches, one end of each of the switches being connected to the other end of each of the plurality of windings, other ends of the switches being interconnected to form a node,
wherein the controller controls the first driving mode to switch to the CEW mode or the OEW mode by turning on/off the plurality of switches.

10. The electrified vehicle of claim 9, wherein the controller controls the driving mode of the motor to switch to the second driving mode based on the first switching condition and the second switching condition being satisfied while the motor is controlled in the CEW mode.

11. The electrified vehicle of claim 1, further including at least one charging switch connected between a node to which the other ends of the plurality of windings are connected and one electrode of the auxiliary battery,
wherein the controller controls the driving mode of the motor to switch to the first driving mode or the second driving mode by turning on/off the charging switch.

12. The electrified vehicle of claim 11, wherein the controller turns on the charging switch, based on both the first switching condition and the second switching condition being satisfied.

13. The electrified vehicle of claim 11, wherein the controller turns off the charging switch, based on at least one of the first switching condition and the second switching condition being not satisfied.

14. A method of controlling an electrified vehicle comprising a motor having a plurality of windings, a first inverter including a plurality of legs each connected to one end of each of the plurality of windings, and a main battery connected to the first inverter, the electrified vehicle being capable of being equipped with an auxiliary battery, the method including:
selectively controlling a driving mode of the motor between a first driving mode in which the motor is driven using only output power of the main battery and a second driving mode in which the motor is driven using the output power of the main battery and output power of the auxiliary battery together based on a first switching condition with respect to a target operating point according to a required torque of the motor and a second switching condition with respect to a required output power of the motor and the output power of the auxiliary battery, in a state in which the electrified vehicle is equipped with the auxiliary battery.

15. The method of claim 14, further including determining that the first switching condition is satisfied, based on the required torque of the motor being included in an area below a torque limit line for each rotation speed of the motor.

16. The method of claim 14, further including determining that the second switching condition is satisfied, based on the required output power of the motor exceeding the output power of the auxiliary battery.

17. The method of claim 14, wherein the controlling includes controlling the driving mode of the motor to switch to the second driving mode, based on both the first switching condition and the second switching condition being satisfied.

18. The method of claim 14, wherein the controlling includes controlling the driving mode of the motor to switch to the first driving mode, based on at least one of the first switching condition and the second switching condition being not satisfied.

19. The method of claim 18, wherein the electrified vehicle further includes a second inverter including a plurality of legs connected to other ends of the plurality of windings and connected to the main battery, and a plurality of switches, one end of each of the switches being connected to the other end of each of the plurality of windings, other ends of the switches being interconnected to form a node,
wherein the first driving mode includes a CEW mode in which the motor is driven using only the first inverter and an OEW mode in which the motor is driven through the first inverter and the second inverter,
wherein the controlling the driving mode of the motor to switch to the first driving mode includes controlling the first driving mode to switch to the CEW mode or the OEW mode by turning on/off the plurality of switches.

20. The method of claim 19, wherein the controlling includes controlling the driving mode of the motor to switch to the second driving mode based on the first switching condition and the second switching condition being satisfied while the motor is controlled in the CEW mode.
